(19) United States
(12) Patent Application Publication
(10) Pub. No.: US 2022/0108347 A1
(43) Pub. Date: Apr. 7, 2022

(54) BLOCKCHAIN BASED COMPUTER SYSTEM FOR MANAGING PRIVATE DATA BY LINKING CRYPTOCURRENCY REWARDS TO THE SHARING OF THE PRIVATE DATA

(71) Applicant: Steven Connell, Honolulu, HI (US)

(72) Inventor: Steven Connell, Honolulu, HI (US)

(21) Appl. No.: 17/062,172

(22) Filed: Oct. 2, 2020

(51) Int. Cl. G06Q 30/02; G06Q 20/06; G06Q 20/38; H04L 12/58

(52) U.S. Cl. CPC G06Q 30/0236; H04L 51/02; G06Q 20/3827; G06Q 20/065

(57) ABSTRACT

A computer system for securely managing private data and providing user rewards for users selectively sharing the private data with third parties, having: (a) a central private data management system; and (b) a plurality of applications running on mobile or fixed-location devices that are configured to: (i) compile private data, (ii) permit the users to select elements of the compiled private data to be selectively shared with the third parties, wherein the central private data management system: (i) receives the selected elements of compiled private data, (ii) performs a demographic and psychographic analysis, (iii) writes the selected elements of compiled private data and the demographic and psychographic metadata into Blockchain blocks, (iv) sells keys to the Blockchain blocks to the third parties, and (v) distributes cryptocurrency to the user's mobile or fixed-location devices.

### TECHNICAL FIELD

The present invention is related to Blockchain based systems for managing private data and for rewarding users for selectively sharing their private data with third parties.

### BACKGROUND OF THE INVENTION

The exploitation of personal data of cell phone and computer users has recently become a very serious issue in society. People are increasingly concerned about the data trail they leave behind and who has access to that data, and how it is being used. Third parties (including phone carriers and companies operating on the internet) can easily gain access to what website users browse, what they say in their emails, what they text, and where they go. As such, these third parties can gain access to users' intimate personal details (including their tastes, interests, medical history, banking records, etc.). Most people today simply do not trust the privacy policies of tech companies either (especially after endless scandals concerning private user information being compromised).

More and more, society is speaking out about the need to keep this sort of data confidential. New privacy legislation is appearing worldwide to protect these troves of private data. The need for individuals to control the dissemination (and resultant use) of their private data has never been greater. In addition to known (i.e.: authorized) parties gaining access to this data, the danger always exists that user's data will be hacked by malevolent third parties (for example, to gain access to credit cards and passwords). As a result, the need for secure formats and approaches to store users' private data has never been greater. Preferably, such a data storage format would be unbreakable.

Another common problem is that users see endless irrelevant and unwanted advertisements. This is annoying to users and extremely cost inefficient for the advertisers. Today, online advertisements have very low click-through rates to actual purchases being made. It would instead be desirable to have the advertisers access user profiles that are up-to-date, accurate and verified by real user activities (prior to sending any advertisements). Unfortunately, previous attempts at building such a system all resulted in compromises to user privacy, security and anonymity.

As a result, the problem third party advertisers face is that although they can tailor their advertising somewhat, they must still use somewhat of a scatter-gun approach. This is because they can never access all of the personal data they would like to access about their potential customers. Advertisers instead would want to target their promotions to users with specific profiles, based on information that has been verified, in addition to being simply self-declared by the users.

In addition, advertisers would like the ability to perform market research by identifying highly specific segments of the user population such that these advertisers could anonymously contact these individuals to answer additional market research questions. Advertisers would even pay these potential customers for this market research service. Unfortunately, no safe and secure system exists for identifying who these individuals are in the first place, and gauge their interest in participating in such market research surveys. To date, no system can perform such a marketing research service without first compromising the identities and intimate online details of these individuals.

Recently, Apple Corporation announced that it may require users to give their explicit permission before letting apps track them for advertising purposes. This announcement caused widespread panic among app developers (who need user data for their own business models). Worldwide, governments are passing new privacy legislation permitting individuals to strictly control the use of their private date. For example, the General Data Protection Regulation (GDPR) enacted in Europe in 2018 gives control to individuals over their personal data and also addresses the transfer of privacy data outside of Europe. Persons in Europe are given the right to see how their data is collected and used, the right to prevent others from accessing or using their personal data and even the “right to be forgotten” (should they wish to terminate others from using their data). In 2019, the California Consumer Privacy Act became the toughest privacy legislation in the US. The objective of the California Consumer Privacy Act was to give all Californians the right to “find out what personal information a business is collecting about them, their devices and their children”.

Lastly, the problem for service providers (including companies such as Apple, Samsung, etc.) is that although they may monitor user activity in their customer networks, they do not actively monetize this user activity. What is instead desired is a system in which these sorts of companies are better able to monetize user activity data, but only do so in a manner that in no way compromises their users' private data without users' consent.

### SUMMARY OF THE INVENTION

In preferred aspects, the present system comprises a computer platform for securely managing private data and providing user rewards for users selectively sharing the private data with third parties. In operation, the present system comprises a Central Private Data Management System, a plurality of downloadable Applications running on mobile or fixed-location computing devices, and a plurality of Third Parties.

The Central Private Data Management System operates as the central communication point and data management hub between the network of Users and a network of Third Parties. The computer Applications that are downloaded onto the users' mobile devices all communicate with the central private data management system. The computer Applications are each configured to: (i) compile private data based on a user's interaction with the mobile (or fixed-location) computing device, (ii) permit the user to select elements of their compiled private data to be selectively shared with the third parties, and (iii) transmit the selected elements of compiled private data to the central private data management system (preferably, this data transmission is encrypted for further user security). As such, the Users allow the release of their Private Data as consideration for the reward generating transaction.

The Central Private Data Management System is configured to: (i) receive the selected elements of compiled private data from each of the Applications running on the mobile devices and fixed-location computers, (ii) perform a demographic and psychographic analysis of the selected elements of compiled private data thereby generating demographic and psychographic metadata, (iii) write the selected elements of compiled private data and the demographic and psychographic metadata into Blockchain blocks, (iv) sell keys to the Blockchain blocks to the third parties, and (v) distribute cryptocurrency to the user's devices (preferably in the form of a Wallet installed on their smart phones). In optional aspects, the Central Private Data Management System distributes fiat currency to the user's device instead of cryptocurrency (or in addition to a cryptocurrency distribution).

In preferred aspects, the Central Private Data Management System sells the keys to the Blockchain blocks to third parties by auctioning the keys with the third parties bidding on the auctioned keys. Preferably, the third parties pay for the auctioned keys in fiat currency (such as US dollars). Optionally, the third parties may pay for the keys in cryptocurrency (or even in some combination of crypto and fiat currencies).

As a reward for sharing their data with third parties, the Central Private Data Management System distributes cryptocurrency (and/or fiat currency) to the users through their mobile devices. Importantly, however, the amounts of cryptocurrency (and/or fiat currency) that each user receives may be different from one another. This is because the amount of cryptocurrency (and/or fiat currency) that each user receives is based on a “calculated worth” of the selected elements of each user's compiled private data. In various approaches, the user's calculated worth can be determined using one or more of the following: the identity of the user, the user activities performed on the computing device, the social media following of the user across different platforms, or the user's financial records (e.g.: recent purchases made through various Apps on a smart phone, the user's net worth, financial credit score, criminal background, etc.). It is to be understood, however, that this list is not exhaustive and the calculated worth can be based on other metrics or data types and defined by either the third parties or by the Central Private Data Management System and that these metrics and calculations can be changed over time.

The Third Parties advertise or sell products or services to the Users. By having access to the selected elements of each of the various users' compiled private data (and/or to the demographic and psychographic metadata associated therewith), the third parties can deliver precisely targeted personalized advertisements to each of these users.

The Central Private Data Management System acts as a hub management system that receives fiat currency payments from third parties and distributes cryptocurrency (and/or fiat currency) to the users. As such, the Central Private Data Management System essentially manages a closed cryptocurrency (and/or fiat currency) ecosystem in which the Users operate. The users are able to use the cryptocurrency (and/or fiat currency) they receive to purchase goods and services within this private ecosystem. In optional aspects, the cryptocurrency (and/or fiat currency) can be used to purchase goods or services directly from the Central Private Data Management System. For example, if the Central Private Data Management System is managed by Apple, then the users can use the cryptocurrency to purchase new Apple iPhones. In other optional aspects, the users can use the cryptocurrency (and/or fiat currency) to purchase goods and services from one another (with the Central Private Data Management System managing the payment transfers of the cryptocurrencies or fiat currencies). In further optional aspects, the third parties also join the currency ecosystem. For example, Verizon could be a third party that joins when the Central Private Data Management System is run by Apple. In that case, the users can use the cryptocurrency they receive from Apple to pay their Verizon phone bills.

One advantage of the present cryptocurrency system is that the cryptocurrency is backed by the collateral of the goods and services within the ecosystem. The Central Private Data Management System issues and manages the cryptocurrency. As such, the value of the cryptocurrency does not “float” like a publicly traded cryptocurrency such as Bitcoin (which moves up or down in value erratically depending upon the whims of the market).

In various optional aspects where users trade the cryptocurrency among themselves, the Central Private Data Management System also acts as a hub management system that simultaneously receives payments from a first group of users in cryptocurrency and sends payments to a second group of users in cryptocurrency. In these preferred aspects, the users providing products or services to one another in exchange for the cryptocurrency.

In optional aspects, a percentage of proceeds of the sale of the keys to the Blockchain blocks is retained by the Central Private Data Management System as a royalty payment. Optionally, the rate of this royalty payment can be changed or adjusted over time. For example, the royalty rate can be increased if the third parties achieve more successful sales levels after using the present system for some time. As more and more users and third parties adopt and use the present system, its value increases, and the royalty rate the Central Private Data Management System is able to charge can increase as well. Moreover, different royalty rates may be set by the operators of the Central Private Data Management System for different third parties or industry groups or third parties or different product or market segments. Specifically, the Central Private Data Management System would be able to ask for higher royalty rates in those industries/sectors/third party groupings, etc. where it is most successful in leading to increased valued sales for those third parties. In addition, the consideration given to Users would be payment or discounts.

The present system also provides a Blockchain based method of rewarding a plurality of users with cryptocurrency (and/or fiat currency) in exchange for selectively sharing private data with third parties, comprising: (a) a plurality of Applications running on a plurality of users' mobile or fixed-location computing devices (e.g.: smartphones) collecting private data corresponding to the users' interaction with these devices; (b) each of the users personally operating their own resident Applications on their devices to select elements of their private data to be shared with third parties; (c) each of the Applications sending the selected private data elements to a Central Private Data Management System; (d) the Central Private Data Management System performing a demographic and psychographic analysis of the selected elements of compiled private data thereby generating demographic and psychographic metadata; (e) the Central Private Data Management System writing the selected elements of compiled private data and the demographic and psychographic metadata into Blockchain blocks; (f) the Central Private Data Management System selling (preferably, by auction) keys to the Blockchain blocks to the Third Parties; and (g) the Central Private Data Management System then distributing cryptocurrency (and/or fiat currency) to the users' devices.

As stated above, the present cryptocurrency is issued and managed by the Central Private Data Management System, and can be traded in this private, closed ecosystem among the various users. The advantages of rewarding the users with a cryptocurrency (as opposed to rewarding them with a fiat currency such as US dollars) are that a private cryptocurrency has liquidity, security, and frictionless covertability. A distinct advantage of using a private cryptocurrency that is issued and distributed by the Central Private Data Management System is that the cryptocurrency is backed both by the collateral of the operations of the Central Private Data Management System and the collateral value of the users' private data's worth to the Third Parties.

The advantage of using a Blockchain-based approach is that the users' private data can be written into Blockchain blocks which are very secure and cannot be hacked. Moreover, as will be further explained, the data written into the Blockchain blocks preferably comprises metadata (as opposed to the true, fully exposed private details of the users). Most preferably, this metadata has been pseudonymized to mask all the unnecessary details of the users' lives. In addition, this metadata preferably comprises demographic and psychographic data, which provides Third Parties with valuable information they can use in orchestrating (very) targeted marketing campaigns, and personalized messages. For example, the Third Party may receive information identifying one User as a “30 year old female Democrat from California” and another as a “65 year old male Republican from Texas”. In accordance with the present system, this level of analysis is carried out by the Central Private Data Management System, which keeping other details of the user's lives and identities safe and secure.

In addition, the advantages of Blockchain storage of the data include the fact that hackers can't modify the data after it has been written into the Blockchain blocks, and the data can be shared piece by piece without revealing the users' identities.

By issuing and using its own privately issued cryptocurrency, the Central Private Data Management System does not need to rely on cryptocurrency issuing or trading agencies (such as Coinbase) outside the ecosystem. Some of these public cryptocurrency issuing or trading agencies operate under somewhat dubious legalities. The present system advantageously does not rely on such external agencies. In addition, the Central Private Data Management System is the sole intermediary between fiat and crypto currencies. As a result, the present system advantageously assigns “agency” to the commercial entity at the helm of the ecosystem (e.g.: Apple, Amazon, Samsung, Verizon, etc.) operating the Central Private Data Management System.

Advantages of the present Application that is downloaded and installed on the various users' devices include at least the following. First, no private data about the user ever leaves their device without their explicit consent. Stated another way, each user actively decides exactly what personal data that they are willing to share. As a result, there is no hidden “tracking” of the user's activities that the users themselves are not fully aware of, and fully approve. Users are also preferably able to easily select blocks of time during which their activities are not tracked by the Application. As such, the users can basically turn the present system “on” or “off” during different periods of the day. Secondly, the users each approve the release of their personal data that is sold to third parties (prior to it being sold). This is a major improvement over current Internet surveillance and tracking approaches (e.g.: cookies). For example, users can select to share data elements including, but not limited to: their browsing histories, their location histories, their app usage histories, their purchase histories, their health and fitness activities, etc. As such, some users may decide to share more data (and thus receive more cryptocurrency and/or fiat currency rewards), whereas other users may decide to share less of this data (and receive less cryptocurrency and/or fiat currency rewards). Each individual user's sharing patterns and preferences may also change over time. As users become more comfortable with using the present system over time, they will likely choose to share more of their private data. The important key to the present system is that each individual user makes these determinations about themselves. There is no agency or company “snooping” in the background on their activities without their consent. This marks a major improvement over current approaches. Moreover, by positively rewarding the individual users (in proportion to the amounts and elements of data they choose to share), the onus is on the user to go after the reward. In contrast, existing tracking systems do not reward users and thus exhaust considerable time and effort trying to “profile” their users' behavior.

In preferred options, each of the computer Applications is further configured for the users to input personal advertising preferences. For example, a user may be contemplating to run a marathon, and simply enter the word “marathon” as an input. The present system would then target sending them advertisements targeted to runners (i.e.: shoes, athletic wear, etc.). Another user may enter the phrase “Caribbean Vacation” to receive offers for vacation packages to the Caribbean. Another person may choose to enter “local restaurants” so they receive advertisements that pop up for those restaurants that are closest to their (always changing) GPS location. Personal advertising preferences may even include inputting “negatives” such as “no restaurants” (for example, for a user trying to stay on a diet who doesn't want to receive any restaurant advertisements at all). The possibilities are endless, but importantly, the user himself/herself is the person actively helping to select the advertisements that they will receive.

In other preferred options, each of the computer Applications is further configured for the users to input user selected marketing research survey preferences. For example, a school teacher may select to input “school supplies”. The marketers of various school supplies could then be placed into contact with this school teacher with an advertisement saying: “We will pay you for taking a survey about what you are looking for when purchasing school supplies”. Should the school teacher decide to accept this advertisement, they would then be given a link to the survey and be paid for their time in taking part in the survey. (Such payment may optionally be in the form of cryptocurrency, fiat currency, or even price discounts from the company running the advertisements). Importantly, due to the Blockchain nature of the present system, the identity and personal data of the person taking part in the marketing survey will not be compromised, or exposed.

In further optional aspects of the present system, an intelligent Bot is included into the Application. This intelligent (preferably AI driven) Bot will analyze the user's interaction with the Application and make suggestions to the user as to what advertising preferences and marketing research survey preferences they should select. For example, the Bot may look at the user's recent GPS and Activity tracking data and conclude that the user has recently started jogging. As such, the Bot may suggest to the user that they start receiving advertisements for athletic wear. With the Bot reviewing the user's old activities (in terms of both their history of purchases/places visited, etc. and their history of previously entered market research activities), the Bot would be able to make personal recommendations to the user, and basically represent their owner as their online agent through which advertising is received. Coupled with Artificial Intelligence, the Bot could be ever learning the user's behaviors and preferences so that the advertising the user receives is best tailored to their needs.

### BRIEF DESCRIPTION OF THE DRAWINGS

FIG. 1 is an illustration of the parties operating the present system, with the Central Private Data Management System operating as the communication and management hub for the present system, showing the flows of data, cryptocurrency and fiat currency among the various parties.

FIG. 2 is an illustration of the interaction between the Central Private Data Management System, various third parties and the Blockchain blocks in which the private data is stored in a verified and unhackable format.

FIG. 3 is a further detailed illustration of the structural components of the Central Private Data Management System, showing the interactions of the various structural components of the system.

FIG. 4 is an illustration of the modules of the present application as installed on a user's mobile device.

FIG. 5 is a flowchart showing overall operation of the present system.

FIG. 6A is an illustration of a first screen of a user's mobile device showing operation of the present system as the user reports their daily activities (or other interval of time's activities).

FIG. 6B is an illustration of a second screen of a user's mobile device showing operation of the present system as the user inputs their advertising preferences.

FIG. 6C is an illustration of a third screen of a user's mobile device showing operation of the present system as the user inputs their marketing research preferences.

FIG. 6D is an illustration of a fourth screen of a user's mobile device showing operation of the present system as the user checks their rewards balance (in cryptocurrency and/or fiat currency) and makes purchases of goods and services within the associated ecosystem.

### DETAILED DESCRIPTION OF THE DRAWINGS

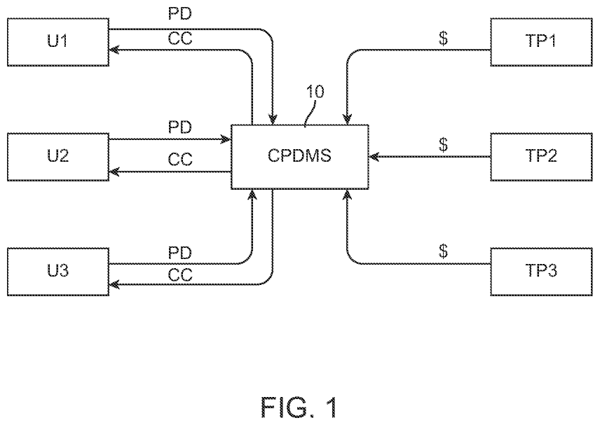

FIG. 1 is an illustration of the parties operating the present system, with the Central Private Data Management System operating as the communication and management hub for the present system, showing the flows of data, cryptocurrency and fiat currency among the various parties, as follows.

A Central Private Data Management System 10 is provided as an interface platform between a plurality of users U1, U2, U3, etc. and a plurality of Third Parties TP1, TP2, TP3, etc. As will be explained in detail herein, each of users U1, U2, U3, etc. provide their own private data PD to Central Private Data Management System 10. As will be further explained, the particulars of each users' private data PD will be unique to the various users since the selection of the data rests at all times under the control of the users themselves. The third parties TP1, TP2, TP3, will primarily be advertisers who are attempting to sell goods and/or services to the various users. As will be explained, third parties TP1, TP2, TP3 will each pay money (e.g.: fiat currency) to the Central Private Data Management System 10 in exchange for access to the private data (and/or metatdata and/or pseudonymized data) of users U1, U2, U3. Optionally, this payment can be made in cryptocurrency, or a combination of fiat and crypto currencies. In addition, users U1, U2, U3 will all be provided rewards (in cryptocurrency) for sharing their private data with the third parties TP, TP2, TP3. Optionally, the users U1, U2, U3 can be rewarded in fiat currency or in some combination of crypto and fiat currencies.

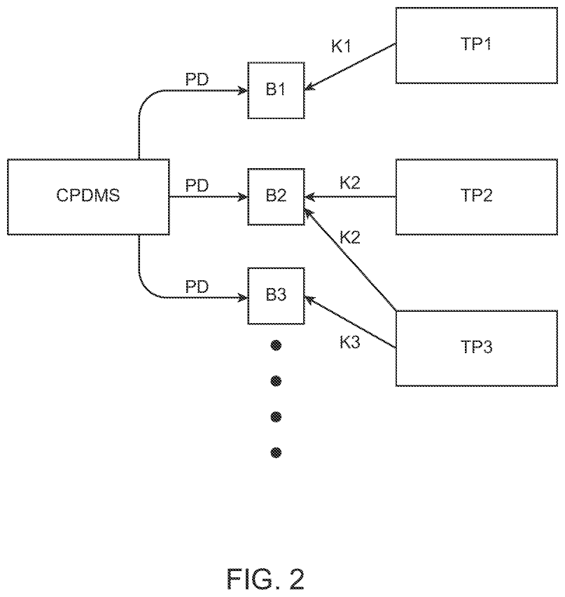

FIG. 2 is an illustration of the interaction between Central Private Data Management System 10, the various third parties TP1, TP2, TP3, and various Blockchain blocks B1, B2, B3, etc. in which the private data PD (of users U1, U2 and U3) is written. By storing the private data PD of users U1, U2 and U3 in Blockchain blocks B1, B2, B3, etc., the private data is stored in a verified and unhackable format. As will be further explained, the data keys K1, K2, K3 to access the data in each of Blockchain blocks B1, B2, B3, are provided by Central Private Data Management System 10 to the various third parties TP1, TP2, TP3 after the various third parties TP1, TP2, TP3 have paid the Central Private Data Management System 10.

In preferred aspects of the present system, the Central Private Data Management System 10 auctions the data keys K1, K2, K3 to the various third parties TP1, TP2, TP3, and the bidding among the various third parties determines the sale price values of the various keys K2, K2, K3. In preferred options, a percentage of the proceeds of the sale of the Blockchain keys can be retained by the Central Private Data Management System in the form of a royalty payment. Additionally, the rate that this royalty payment is set at may be varied depending upon the “success” of the present system. Specifically, if the present system greatly assists one particular group of Third Parties (e.g.: a particular industry segment, geographic area, etc.), then the Central Private Data Management System may be able to demand a higher royalty rate when working with these particular users. Moreover, as adoption of the present system increases over time, then the royalty rate demanded to operate the system may increase accordingly. Stated another way, the more commercially useful the information stored in the Blockchain blocks is to the Third Party advertisers, the higher the royalty rate that can be charged by the company operating and controlling the Central Private Data Management System.

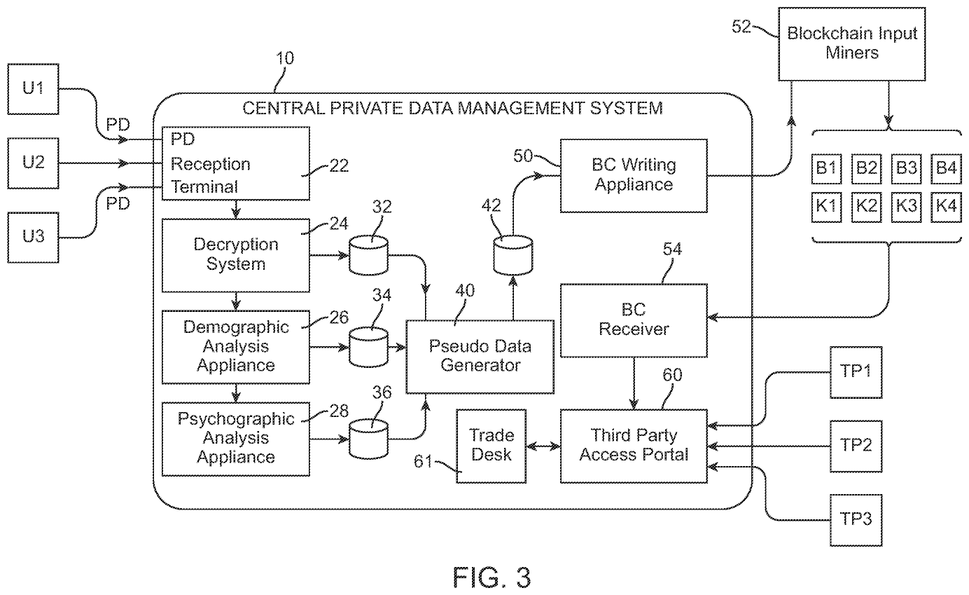

FIG. 3 is a further, more detailed illustration of the structural components of the Central Private Data Management System 10, showing the interactions of the various structural components of this data management system, as follows. (It is to be understood that this illustrated embodiment is merely exemplary, and that the present system may operate with more internal structural components, or with fewer internal structural components, all keeping within the scope of the presently claimed invention).

Here, users U1, U2 and U3 each send their selected and encoded private data PD over their cellular networks, the Internet or other wired or wireless network to Central Private Data Management System 10. This private data is received at one or more Private Data Reception Terminals 22. As the private data sent by the Users is preferably first encrypted (by the Applications resident and operating on their various mobile devices), the private data received by terminal 22 is then sent to a Decryption System 24 where it is decrypted. This decrypted private data can optionally be stored in database 32.

Preferably, the Central Private Data Management System 10 provides further value to the private data PD by passing the data through a Demographic Analysis Appliance 26. Demographic Analysis Appliance 26 analyzes the private data that the various users send such that the private data can be sorted or categorized demographically. For example, Demographic Analysis Appliance 26 may add information to the private data stating that user U1 is a “30 year old female Democrat from California”, whereas user U2 is a “65 year old male Republican from Texas”. It is to be appreciated that many different demographics can be analyzed, including but not limited to: age, location, sex, income, health, etc. These demographic analysis categories can also be changed over time, as desired. This demographic data can optionally be stored in database 34.

This demographic analysis adds real value to the data as it both further protects the users' privacy (by masking their identity), and also provides useful information that Third Party advertisers TP1, TP2, TP3 can use in targeted marketing campaigns.

Preferably as well, the users' private data can also be sent to a Psychographic Analysis Appliance 28. Psychographic Analysis Appliance 28 may add information to the private data stating that user U1 is “interested in religion”, whereas user U2 is “interested in reading real estate listings”. It is to be appreciated that many different psychographics can be analyzed, including but not limited to: political affiliation, religious affiliation and personal habits when looking for (or when purchasing) various goods and services. This psychographic data can optionally be stored in database 36.

This psychographic analysis adds real value to the data as it both further protects the users' privacy (by masking their identity), and also provides useful information that Third party TP advertisers TP1, TP2, TP3 can use in targeted marketing campaigns.

All of the personal data (and associated metadata) from databases 32, 34 and 36 can also be passed to a Pseudonym Data Generation System 40. (Alternatively, the personal data can be passed directly from Demographic and Psychographic Analysis Appliances 26 and 28 directly to Pseudonym Data Generation System 40. It is to be understood that the present system encompasses all forms of data transmission among its various components. Pseudonym Data Generation System 40 operates to perform pseudonymization on the data. Pseudonymization is a data management and de-identification procedure by which personally identifiable information fields within a data record are replaced by one or more artificial identifiers, or pseudonyms. This further strengthens user privacy. The pseudonymized data (meta data) can optionally be stored in database 42.

Next, the data that has been passed through the various components of the Central Private Data Management System 10 is then written into Blockchain blocks, as follows. A Blockchain Writing Appliance 50 sends the data to Blockchain Input Miners 52 who then write the Blockchain blocks B1, B2, B3, etc. and their associated keys K1, K2, K3, etc. The blocks and keys are then received by Blockchain Receiver 54. Next, Central Private Data Management System 10 hosts a Third Part Access Portal (e.g.: website) 60 through which third parties TP1, TP2, TP3, etc. can bid on auctioned keys K1, K2, K3 etc. Once the prices of the keys are determined (either by auction or by Central Private Data Management System 10 setting the price, or by some combination of these approaches), then the keys to the Blockchain blocks can then be sent to the third parties. Also included is an optional Trade Desk® auction module 61 which uses computer algorithms and optional AI to negotiate price the Third Parties pay for the Private Data.

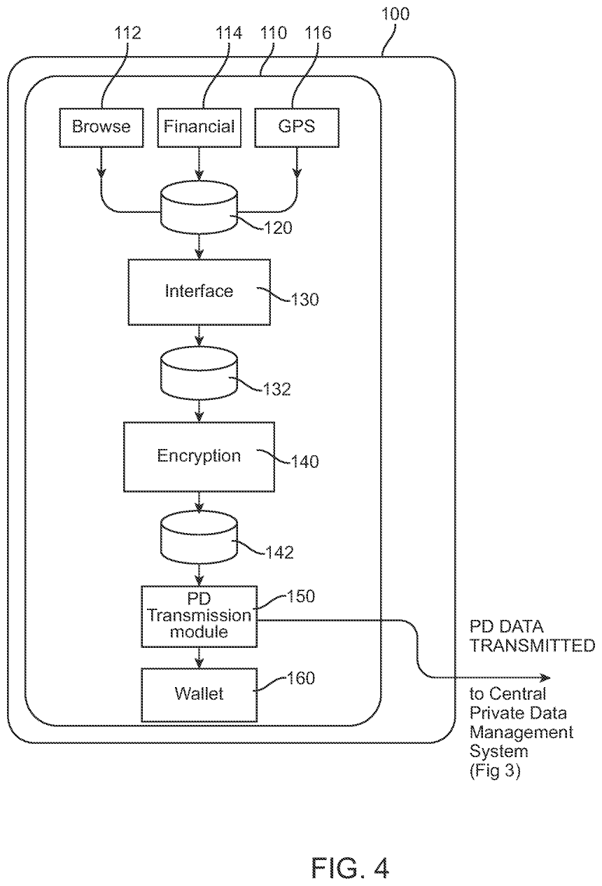

FIG. 4 is an illustration of the software modules of the present Application 110 as installed on a user's mobile device 100, as follows. Application 110 is downloaded and runs on mobile devices such as smartphones. (Alternatively, however, it can optionally also be downloaded to run on fixed-location devices). Application 110 communicates with the Central Private Data Management System 10. In operation, Application 110 is configured to: (i) compile private data based on a user's interaction with the mobile or fixed-location device, and (ii) permit the user to select elements of the compiled private data to be selectively shared with the third parties. Application 110 then transmits the selected elements of compiled private data to the Central Private Data Management System 10.

Further optional details of Application 110 may include a Browsing Module 112 that records the user's browsing history, a Financial Module 114 that records the user's purchasing history, and a Location Module 116 that records the user's location/GPS data history. The data from each of these three modules may optionally be stored in database 120. Together software modules 112, 114, and 116 provide a detailed analysis of (a) where the user is, (b) what the user has purchased through various apps or webpages on the smartphone, and (c) what the user has been looking at on the Internet. This combined information is both very valuable to advertisers (i.e.: third parties TP) and very personal to the user himself/herself.

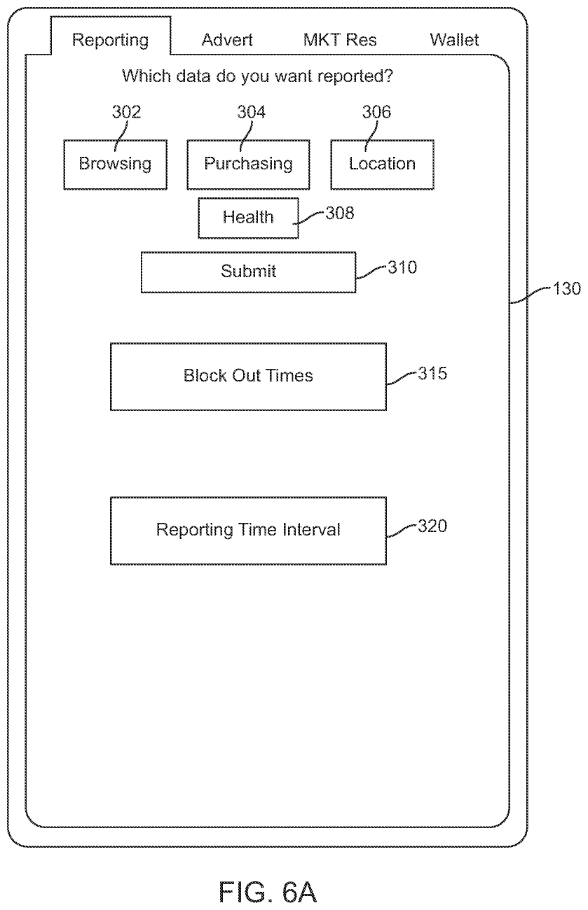

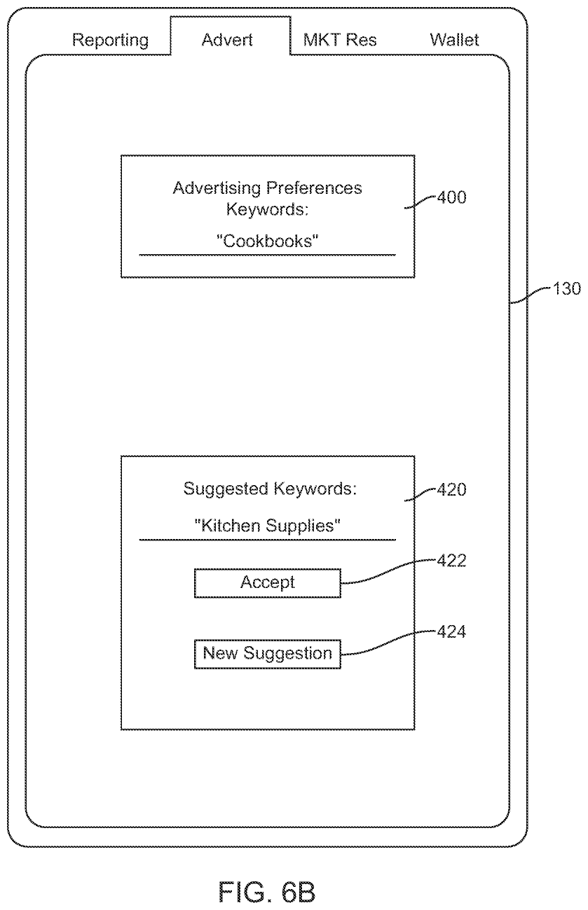

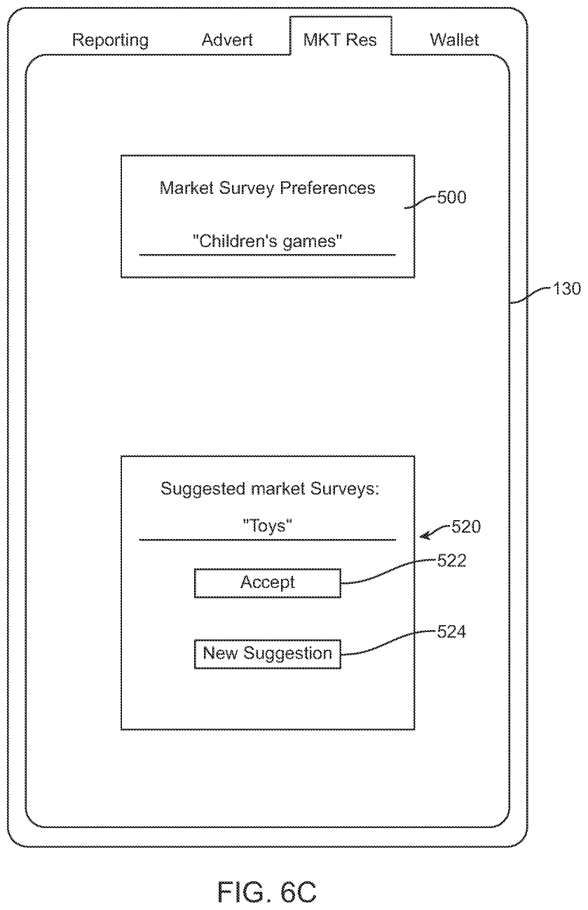

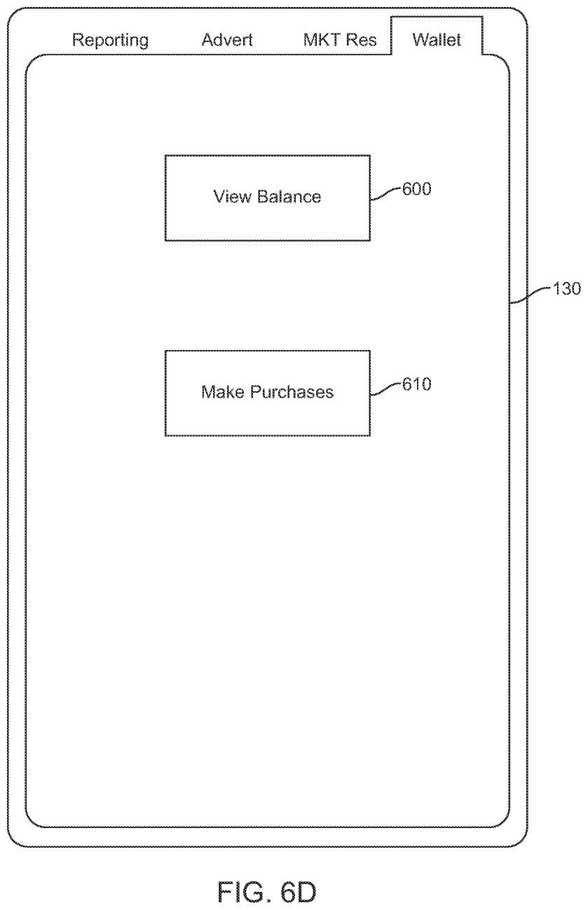

Accordingly, Application 110 provides an Interface 130 (further described with reference to FIGS. 6A to 6D) through which the user actively interacts to select exactly what data they are comfortable sharing with third parties. The incentive for sharing data is that the more data that the user shares, the greater the amount of cryptocurrency the user receives. Importantly, the user personally controls which data they are willing to share. One user may wish to share their location and internet browsing history, but not their online purchase history; whereas another user may only wish to share their location history. Another user may decide to select only their internet browsing data, only their GPS data, or some combination of both. Yet another user may also decide to select only the data of purchases they make (for example sharing only their Apple Wallet or Apple Pay data). The data collected by software Application 110 can include internet browsing data, GPS/location data, data from apps including Apple Wallet and Apple Pay, data concerning physical movements (Apple Maps and Apple Calendar), health data (Apple Health, Fitbit, etc.). There are as many different possibilities as there are different users.

Moreover, each of the users are free to change their sharing patterns and preferences over time. In optional preferred methods of use, the data collected by modules 112, 114 and 116 is preferably reviewed once a day by the user. At this time, the user selects which of their day's activities/data they wish to share. It is to be understood, however, that the present system may be operated to share data at other periods of time (for example, weekly if that is the user's personal preference).

The data selected by the user to be shared with third parties can then be stored in database 132. Whenever the user decides to send the private data (e.g.: from database 132) to the Central Private Data Management System 10, the data can be sent to Encryption Module 140 (and then optionally stored in database 142). Finally, Private Data Transmission Module 150 can send the data on to Central Private Data Management System 10 of FIG. 3.

The data manager operating the Central Private Data Management System will then sell the data to the Third Parties (so that the Third Parties can better send targeted advertising to those particular Users). To ensure data secrecy, the Central Private Data Management System 10 stores the private data in Blockchain blocks B1, B2, B3, etc. and then sends the Blockchain keys tK1, K2, K3, etc. to the Third Parties (when payment has been received). As stated above, the users U1, U2, U3, etc. are rewarded in cryptocurrency. In alternate embodiments, the users may instead or also rewarded in fiat currency, or some combination of crypto and fiat currencies. This cryptocurrency (or fiat currency) can be stored in a Wallet 160 on the mobile device. To encourage user spending of the crypto (or fiat) currency, the Wallet 160 can be programmed to provide: a monthly reminder of balance, suggestions as to how to spend the crypto (or fiat) currency (for example, based on targeted advertisements of the third parties), etc. Optionally, Wallet 160 may also permit users to track the purchases they made in the crypto (or fiat) currency. Optionally as well, Wallet 160 may even permit certain users that are good credit risks to carry a debt balance.

The crypto (or fiat) currency is distributed to the user's mobile devices and managed by the Central Private Data Management System 10. In preferred aspects, the crypto (or fiat) currency is distributed to the user's mobile or fixed-location devices in amounts propositional to a “calculated worth” of the selected elements of each user's compiled private data. The calculated worth can optionally be determined by one or more of the following: the identity of the user, user activities performed on the smart device, user financial records, or social media following of the user. It is to be understood, however, that this list is not exhaustive. Other metrics can be used to determine the calculated worth of various user's private data. For example, a user who has a large social media following may be rewarded more for access to their private data (as compared to a little-known user).

In preferred aspects, the Central Private Data Management System 10 sells the keys K1, K2, etc. to the Blockchain blocks B1, B2, etc. to the third parties in fiat currencies. As such, the Central Private Data Management System 10 is configured to: receive payments from the Users for the Third Party goods or services in crypto (or fiat) currency, and send payments to the third parties for the third party goods or services in fiat (or crypto) currency.

As a result, the Central Private Data Management System 10 preferably acts as the intermediary between the cryptocurrency ecosystem of users and the fiat currency ecosystem of third parties. Cryptocurrencies offer the benefits of liquidity, zero cost per transaction, security, and convertibility into cash (or into other cryptocurrencies). One advantage of a cryptocurrency is that it's easy to transact with the users in. Another advantage of a cryptocurrency is that as its value increases, users are tempted to share more and more private data.

In preferred aspects, the Blockchain system is a closed or private system, set up and completely administered by the Central Data Privacy Management System 10. However, such a Blockchain creation system can be set up with programs like IBM's open source Hyper Ledger. With a permissioned Blockchain like Hyper Ledger, the parties that can use the Blockchain must first be approved before they can access the Blockchain. This permissioning eliminates the need for the incredibly wasteful act of mining on a public Blockchain. Preferably, the total amount of Blockchain tokens is pre-determined by the Central Data Privacy Management System.

The Third Parties advertise or sell products or services to the Users. Targeted advertising is possible since the products or services sold by the Third Parties correspond to at least one of the selected elements of compiled private data or to the demographic and psychographic metadata stored in the Blockchain blocks. In optional preferred aspects, the Users are free to trade the crypto (or fiat) currency among one another (for example, if the Users provide products or services to one another in exchange for the cryptocurrency). In such instances, the Central Private Data Management System is configured to simultaneously receive payments from a first group of Users in cryptocurrency and send payments to a second group of Users in cryptocurrency.

It is expected that Third Party data carriers (such as the phone companies themselves) can and will eventually join the present ecosystem. In these situations, the Users may even pay their phone bill to the Third Party carrier in cryptocurrency, and buy a new iPhone from Apple's own Central Private Data Management System. This is expected to increase the value of the cryptocurrency itself (as spreading the use of the cryptocurrency increases its value). The spreading use of the cryptocurrency will also maintain the stability of the cryptocurrency. In further alternate embodiments, the users themselves have the ability to auction the access to their private data to the third parties.

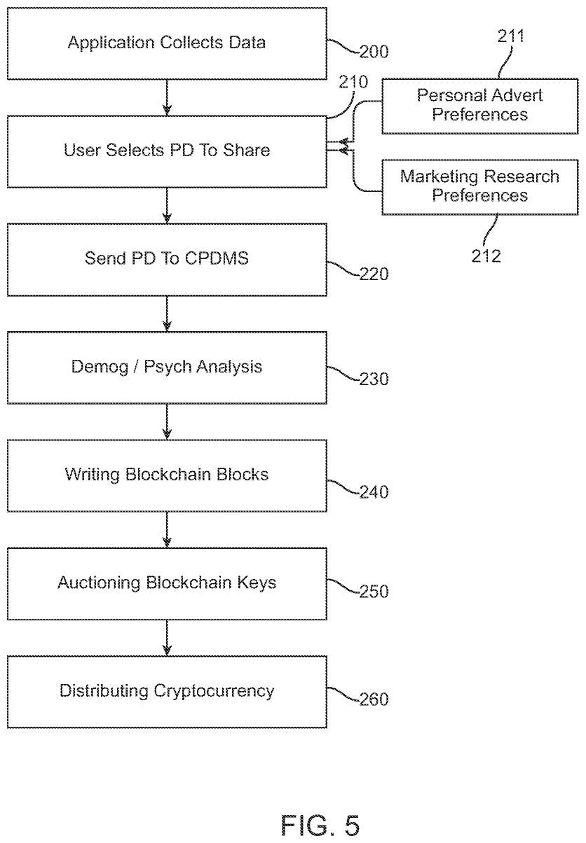

FIG. 5 is a flowchart showing overall operation of the present system, as follows. The preferred Blockchain based method of rewarding a plurality of users with crypto (or fiat) currency in exchange for selectively sharing private data with third parties may comprise the following steps.

At step 200, an Application downloaded on a User's mobile or fixed-location device collects private data corresponding to the users' interaction with the device.

At step 210, the User operates the Application to select elements of their private data to be shared with Third Parties. At step 211, the User can add optional personal advertising preferences. For example, the User may wish to receive advertisements of a particular nature or service, and may indicate here their preference to receive such advertisements (e.g.: the User may enter “Chinese Food”, “New Cars”, or “Florida vacations”, etc.) so as to ensure that they receive more advertisements for these pre-selected advertisement topics. At step 212, the User can add optional information on market surveys they wish to participate in. The present Application will then work to link the User to Third Parties running marketing surveys for these selected topics. The advantage of optional step 211 is that the User is basically writing their own advertising profile and easily controlling the advertisements that they wish to see. This offers huge advantages in effective targeted advertising. The advantage of optional step 212 is that it affords experts in particular subject areas the opportunity to be rewarded for the knowledge and expertise that they have in those subject areas. Third Party advertisers would love to have direct access to persons who can really help them in formulating their product line offerings. With the present system, this is now possible. Moreover, this is accomplished while still protecting the private data of the Users.

At step 220, the Application sends the selected private data elements to a Central Private Data Management System.

At step 230, the Central Private Data Management System performs a demographic and psychographic analysis of the selected elements of compiled private data thereby generating demographic and psychographic metadata.

At step 240, the Central Private Data Management System writes the selected elements of compiled private data and the demographic and psychographic metadata into Blockchain blocks.

At step 250, the Central Private Data Management System 10 auctions and selling the keys to the Blockchain blocks to the Third Parties (thus allowing the Third Parties to gain access to the private data, and its associated demographic and psychographic data and associated metadata). These sales are preferably performed in fiat currencies. But optionally, they can be performed in cryptocurrencies as well. Moreover, the auctioning process can even be handled with an automated system such as Trade Desk®.

At step 260, the Central Private Data Management System distributes cryptocurrency to the User's mobile devices. Optionally, fiat currency rewards (or coupons having values corresponding to the fiat or cryptocurrency) may also be distributed. Preferably, the Central Private Data Management System distributes cryptocurrency to the users in amounts that are propositional to a calculated worth of the selected elements of each user's compiled private data.

The Central Private Data Management System 10 can optionally also conduct trading of the cryptocurrency among the Users (for example when the users provide products or services to one another in exchange for the cryptocurrency).

FIGS. 6A to 6D illustrate various optional screens of the User's mobile device showing operation of the mobile device, as follows. FIG. 6A shows an interface for reporting the user's daily activities. FIG. 6B shows the User inputting their advertising preferences. FIG. 6C shows the User inputting their marketing research preferences. Lastly, FIG. 6D shows the User checking their rewards balance (in cryptocurrency and/or fiat currency) and making purchases of goods and services within the associated ecosystem.

FIG. 6A shows a first screen of interface 130 where the User selects which private data they wish to report. Specifically, the user may select to report their daily browsing data by selecting button 302, their daily purchasing data by selecting button 304, their daily location/GPS data by selecting button 306, their health/activity/fitness tracking data by selecting button 308. The user may select any combination of buttons 302, 304, 306 and 308 before hitting “submit” button 310. It is to be understood that these four buttons are merely exemplary and that other categories of private data types and categories may also be included. The User may even push optional button 315 to select any “block out times” during the day during which they do not want any of their private data reported. This feature gives the User the ability to basically turn the present system off and on during the day (further increasing the User's privacy, as desired). Optional button 320 allows the User to select other time periods during which they'd choose to report their private data. For example, some users may instead desire to report their data on a weekly or monthly period of time. Some users may even wish to report more than once a day. In addition, the User is preferably also given the option at 320 either to turn their data reporting to “automatically on” (which that reporting is carried on without requiring their input), or “automatically off” (such that the User has to go into the App and make the positive action of reporting their data). Over time after trust has built up, more and more users are expected to leave their systems “always on”.

FIG. 6B illustrates the User entering their personal “advertising preferences” at button 400. For example, a User starting a fitness training program may enter “athletic clothing” and “running shoes” such that they start to receive advertisements for these products. Another user may enter “Christmas decorations” such that they start receiving these sorts of advertisements as the holiday season approaches. Another user may select “Cookbooks”. In preferred optional embodiments, the present Application comprises an intelligent AI driven Bot that reviews the User's previous activities (as previously recorded and reported in the User's private data). This Bot then makes suggestions at 420. For example, the Bot may detect that the User has recently purchased a number of cookbooks, and accordingly make the suggestion “Kitchen Supplies” as something the User may wish to receive more advertisements about. The User is then free to push the “accept” button 422 or reject and push the “new suggestion” button to generate a new suggestion. As the Bot is coupled with Artificial Intelligence, it will learn the User's behaviors over time and the quality and the timing of new suggestions will constantly improve.

FIG. 6C illustrates the User entering their personal “marketing research survey” preferences at button 500. For example, a User may wish to participate in surveys about particular goods or services because those goods or services are ones they know well. A medical doctor may enter “medical equipment”, a veterinarian may enter “pet food”, a school teacher may select “school supplies”, etc. Third Party advertisers would love an easy method to contact these “experts”, and the present system provides such a system, all without compromising User privacy. Third Party advertisers can then work with the Users who would like to participate in their market research surveys. A user selecting “Children's Toys” at 500 may be asked by the Bot whether they also want to participate in surveys about “Toys” at 520. Moreover, the Third Party advertisers can optionally pay the selected Users for their time and expertise. Such payment can optionally be made in the form of cryptocurrency, fiat currency, discounts or coupons for the Third Party's produces or services, or some combination of any or all of these.

Lastly, FIG. 6D illustrates an interface where Users can check their account balance in the Wallet (160 in FIG. 4). Should the Wallet contain both cryptocurrency and fiat currency balances, separate tallies for each may be presented. Button 610 affords the Users the option of making purchases with the balance(s) in their Wallet.

In further alternate embodiments, the present system provides a computer platform for rewarding Users with cryptocurrency tokens in exchange for private data, comprising: (a) an application running on a mobile device, the application being configured to: (i) track user browsing data; (ii) permit a User to select particular browsing data; (ii) permit the User to upload the selected particular browsing data; (b) a private data management platform configured to: (i) receive the uploaded selected particular browsing data from a plurality of Users; (ii) write the uploaded selected particular browsing data onto Blockchain blocks; (iii) send Blockchain keys to third parties to unlock the Blockchain blocks; and (iv) issue cryptocurrency tokens to the users in exchange for uploading their selected particular browsing data. In alternate embodiments, fiat currency may also be issued to the Users.

In further alternate embodiments, the present system provides a Blockchain-based architecture for managing private data, comprising: (a) a plurality of computer applications resident on a plurality of smart devices for collecting user private data; (b) an administrator system in communication with the plurality of computer applications and in communication with a plurality of third parties, wherein the administrator system: (i) receives the user private data from the plurality of computer applications, and uploads the user private data into Blockchain blocks, (ii) sells keys to the Blockchain blocks to the third parties, thereby permitting the third parties to access the user private data, and (iii) distributes a private cryptocurrency (and/or fiat currency) to the plurality of computer applications.

The intelligent Bot (a.k.a.: “personal concierge”) described in FIGS. 6B and 6C above, can optionally make suggestions to the Users as to their advertising preferences and market research survey preferences. As such, the Bot functions as the User's personal assistant and helps the User find the products and services that they are looking for. The Bot automatically searches for products and services on the platform and in the ecosystem, thereby promoting use of the present platform and ecosystem. The Bot prioritizes the products/services when it makes suggestions to the User, and also looks for the best offers and values. In effect, the advertisements that the User receives are now based on the User's own activities, and/or their new hobbies and interests. Both Users and Third Party advertisers value the present system as it removes (or significantly cuts down on) advertisements that are unwanted by the User and are a waste of time for the Third Party advertisers to send.

In one example, the User simply uploads their activity data. The intelligent Bot in the App quickly realizes that the user has started jogging a little each day, first 1 mile, then 2 miles, 5 miles, etc. The Bot would then infer that the user is interested in fitness and could begin asking the User questions such as: “Are you training for a marathon?” and “Do you want me to recommend a training schedule for you?”. If this User's interest is confirmed, the present App would begin to make recommendations for relevant products (shoes, books) and services (personal trainer, upcoming 10K races in their area) that are most likely to help the user achieve this goal.

In another similar example, the user decides he wants to run his first marathon by the end of the year and directs the AI Bot to begin searching for resources (products, services, recommendations) that will help him/her achieve this goal. The AI bot assembles a training plan, targeted product recommendations, educational resources, upcoming events, etc. and shows the user advertisements & promotions for these items. E.g. “Users of your age and gender that begin training 6 months in advance with the following training plan have a 78% probability of successfully completing their first marathon. The new Nike Pegasus 4.0 shoe has the highest rating from users with your body profile and fitness level. Do you want to continue receiving recommendations about this topic?”

As can be seen, the present Bot essentially functions as an “intelligent concierge” service that engages in an iterative process with the User/consumer to find, refine and continuously update the User's needs and wants. This “concierge” can ask the User what they are looking for and then, given its access to a vast database of product and service offerings, can tell the User where to find what they seek. Additionally, by employing AI, the concierge (i.e.: Bot) can suggest things the User had not even thought of. This is because the Bot listens to the User's questions and responses and adjusts its synopsis of who the User is and what the User wants. This iterative process increases accuracy over time. The result of this iterative process is better (and therefore more valuable), information for the Third Party advertisers. These Third Party advertisers will pay more for services such as this. Database providers like Microsoft, IBM, and Oracle, who today lack consumer touch points, may have a keen interest in this technology.

In preferred aspects of the present system, a “concierge query” is performed. Specifically, unlike a database query, which is a query of the raw database, a concierge query is an elevated query whereby the Third Party directly queries the present concierge (Bot) instead of the raw database. Thanks to iterative marketing, the concierge (Bot) has better information for the inquirer than the raw personal user database because likes and dislikes of the user derived from the raw data points are re-calibrated regularly using direct user interventions. Users can optionally regularly download their most up-to-date concierge into the Blockchain for Third Party access just as they can their unvarnished information.

In preferred aspects, “iterative data mining” (also to be known as “dialectic data mining”) can be performed by the use of repeated user interventions during AI data mining, via the concierge, to better determine the true likes and dislikes of the User. The User steps in and directly reveals to the personal concierge what he or she wants, and conversely (inversely) the personal concierge makes suggestions to the User which the User affirms or denies (FIGS. 6B and 6C).

In many ways, the present system moves from today's “targeted” marketing to tomorrow's next-generation “iterative” marketing. Today artificial intelligence, a data-intensive process, resides at the data center, remote from the consumer. No one has yet taken artificial intelligence to the “last mile,” i.e., to the touch point with the consumer. In contrast, the present intelligent Bot system: (a) resides at the consumer touch point (e.g. the cell phone) and (b) downloads data collected there to a distributed database (the Blockchain). As such, the present system has the opportunity to employ AI at the data center and bring it back for the consumer to enjoy. To date, no one else is operating such a system.

What is claimed is:

1. A computer system for securely managing private data and providing user rewards for users selectively sharing the private data with third parties, comprising:
(a) a central private data management system; and
(b) a plurality of applications running on mobile or fixed-location devices, wherein each of the plurality of applications communicates with the central private data management system, and wherein each of the applications is configured to:
(i) compile private data based on a user's interaction with the mobile or fixed-location device,
(ii) permit the user to select elements of the compiled private data to be selectively shared with the third parties, and
(iii) transmit the selected elements of compiled private data to the central private data management system, and
wherein the central private data management system is configured to:
(i) receive the selected elements of compiled private data from each of the applications running on the mobile or fixed-location devices,
(ii) perform a demographic and psychographic analysis of the selected elements of compiled private data thereby generating demographic and psychographic metadata,
(iii) write the selected elements of compiled private data and the demographic and psychographic metadata into Blockchain blocks,
(iv) sell keys to the Blockchain blocks to the third parties, and
(v) distribute cryptocurrency to the user's mobile devices.

2. The computer system of claim 1, wherein the central private data management system is configured to sell the keys to the Blockchain blocks to third parties by auctioning the keys with the third parties bidding on the auctioned keys.

3. The computer system of claim 2, wherein a percentage of proceeds of the sale of the keys to the Blockchain blocks is retained by the central private data management system as a royalty payment.

4. The computer system of 3, wherein the percentage varies in relation to the amount of sales made by the third parties to the users based on information in the Blockchain blocks.

5. The computer system of claim 1, wherein the central private data management system distributes cryptocurrency to the user's mobile or fixed-location devices in amounts propositional to a calculated worth of the selected elements of each user's compiled private data.

6. The computer system of claim 5, wherein the calculated worth is determined by at least one of the following: the identity of the user, user activities performed on the smart device, user financial records, or social media following of the user.

7. The computer system of claim 1, wherein the central private data management system sells the keys to the Blockchain blocks to the third parties in fiat currency.

8. The computer system of claim 1, wherein the central private data management system sells the keys to the Blockchain blocks to the third parties in cryptocurrency.

9. The computer system of claim 1, wherein each of the plurality of applications is further configured to:
(iv) receive at least one of the following user inputs:
(a) user selected personal advertising preferences, or
(b) user selected marketing research survey preferences.

10. The computer system of claim 9, wherein the user inputs are added to the private data for inclusion into the Blockchain blocks.

11. The computer system of claim 1, wherein the third parties advertise or sell products or services to the users.

12. The computer system of claim 11, wherein the products or services correspond to at least one of the selected elements of compiled private data or to the demographic and psychographic metadata.

13. The computer system of claim 1, wherein the central private data management system is configured to:
receive payments from the users for the third party goods or services in cryptocurrency, and
send payments to the third parties for the third party goods or services in fiat currency.

14. The computer system of claim 1, wherein the central private data management system is configured to simultaneously receive payments from a first group of users in cryptocurrency and send payments to a second group of users in cryptocurrency.

15. The computer system of claim 14, wherein the users provide products or services to one another in exchange for the cryptocurrency.

16. The computer system of claim 1, wherein the selected elements of compiled private data comprise at least one of the following:
browsing data, GPS/location data, or financial data.

17. The computer system of claim 1, wherein each of the plurality of applications comprises:
a computer Bot that suggests at least one of:
(a) personal advertising preferences, or
(b) marketing research survey preferences,
for the user to select and input into the application.

18. The computer system of claim 17, wherein the computer Bot suggests the personal advertising or marketing preferences based upon the user's:
(a) previously compiled private data, or
(b) previously inputted personal advertising or marketing preferences.

19. A computer system for securely managing private data and providing user rewards for users selectively sharing the private data with third parties, comprising:
(a) a central private data management system; and
(b) a plurality of applications running on mobile or fixed-location devices, wherein each of the plurality of applications communicates with the central private data management system, and wherein each of the applications is configured to:
(i) compile private data based on a user's interaction with the mobile or fixed-location device,
(ii) permit the user to select elements of the compiled private data to be selectively shared with the third parties, and
(iii) transmit the selected elements of compiled private data to the central private data management system, and
wherein the central private data management system is configured to:
(i) receive the selected elements of compiled private data from each of the applications running on the mobile or fixed-location devices,
(ii) perform a demographic and psychographic analysis of the selected elements of compiled private data thereby generating demographic and psychographic metadata,
(iii) write the selected elements of compiled private data and the demographic and psychographic metadata into Blockchain blocks,
(iv) sell keys to the Blockchain blocks to the third parties, and
(v) distribute fiat currency to the user's mobile devices.

20. The computer system of claim 19, wherein the central private data management system is configured to:
(a) sell the keys to the Blockchain blocks to third parties by auctioning the keys with the third parties bidding on the auctioned keys, and
(b) distribute fiat currency to the user's mobile or fixed-location devices in amounts propositional to a calculated worth of the selected elements of each user's compiled private data.

21. The computer system of claim 19, wherein each of the plurality of applications is further configured to:
(iv) receive at least one of the following user inputs:
(a) user selected personal advertising preferences, or
(b) user selected marketing research survey preferences.

22. The computer system of claim 19, wherein each of the plurality of applications comprises:
a computer Bot that suggests at least one of:
(a) personal advertising preferences, or
(b) marketing research survey preferences,
for the user.

23. The computer system of claim 22, wherein the computer Bot suggests the personal advertising or marketing preferences based upon the user's previously compiled private data.

24. A Blockchain based method of rewarding a plurality of users with cryptocurrency in exchange for selectively sharing private data with third parties, comprising:
(a) a plurality of applications running on a plurality of users' mobile or fixed-location devices collecting private data corresponding to the users' interaction with the mobile devices;
(b) each of the users operating the applications to select elements of their private data to be shared with third parties;
(c) each of the applications sending the selected private data elements to a central private data management system;
(d) the central private data management system performing a demographic and psychographic analysis of the selected elements of compiled private data thereby generating demographic and psychographic metadata;
(e) the central private data management system writing the selected elements of compiled private data and the demographic and psychographic metadata into Blockchain blocks;
(f) the central private data management system selling keys to the Blockchain blocks to the third parties; and
(g) the central private data management system distributing rewards to the user's mobile or fixed-location devices.

25. The method of claim 24, wherein the rewards are distributed in cryptocurrency.

26. The method of claim 24, wherein the rewards are distributed in fiat currency.

27. The method of claim 24, further comprising:
the central private data management system auctioning the keys with the third parties bidding on the auctioned keys.

28. The method of claim 24, further comprising:
the central private data management system distributing the rewards to the user's mobile or fixed-location devices in amounts propositional to a calculated worth of the selected elements of each user's compiled private data.

29. The method of claim 24, wherein the central private data management system sells the keys to the Blockchain blocks to the third parties in fiat currencies.

30. The method of claim 24, wherein the third parties advertise or sell products or services to the user that correspond to at least one of the selected elements of compiled private data or to the demographic and psychographic metadata.

31. The method of claim 24, further comprising:
the central private data management system simultaneously receiving payments from a first group of users in cryptocurrency and sending payments to a second group of users in cryptocurrency.

32. The method of claim 24, further comprising:
sending a percentage of proceeds of the sale of the keys to the Blockchain blocks to the central private data management system as a royalty payment.

33. The method of claim 32, further comprising:
varying the percentage in relation to the amount of sales made by the third parties to the users based on information in the Blockchain blocks.

34. The method of claim 24, further comprising:
(h) each of the plurality of applications receiving at least one of the following user inputs:
(a) user selected personal advertising preferences, or
(b) user selected marketing research survey preferences.

35. The method of claim 34, wherein a computer Bot suggests at least one of the:
(a) personal advertising preferences, or
(b) marketing research survey preferences,
for the user to select and input into the application.

36. The method of claim 35, wherein the computer Bot suggests the personal advertising or marketing preferences based upon the user's:
(a) previously compiled private data, or
(b) previously inputted personal advertising or marketing preferences.
